(19) United States
(12) Patent Application Publication
(10) Pub. No.: US 2024/0211828 A1
(43) Pub. Date: Jun. 27, 2024

(54) SYNERGISTIC TEAM FORMATION

(71) Applicant: Kyndryl, Inc., New York, NY (US)

(72) Inventors: Sachio IWAMOTO, Richmond Hill (CA); Susanna TING, Markham (CA); Janice EDGECOMBE, Newmarket (CA); Neil DELIMA, Scarborough (CA); Peter Henry BURTON, Vancouver (CA)

(21) Appl. No.: 18/088,159

(22) Filed: Dec. 23, 2022

(51) Int. Cl. G06Q 10/0631; G06Q 10/0639; G06Q 10/101

(52) U.S. Cl. CPC G06Q 10/063112; G06Q 10/06398; G06Q 10/101

(57) ABSTRACT

Aspects of the present disclosure relate generally to the formation of project teams and, more particularly, to systems and method of forming synergistic teams. For example, a computer-implemented method includes receiving, by a processor, a project profile including project skills; searching, by the processor, employee profiles for employee skills matching the project skills; selecting, by the processor, at least one group of team candidates having employee profiles with employee skills collectively matching the project skills; determining, by the processor, a synergy score for the at least one group of team candidates; and saving, by the processor, the synergy score and the group of team candidates in persistent storage.

### BACKGROUND

Aspects of the present invention relate generally to the formation of project teams and, more particularly, to systems and method of forming synergistic teams.

Team forming exercises today in large corporations primarily consider individual skills applicable for a given project and availability of individuals for the project duration. Guidance in selecting project team members often falls upon senior management who have broad organizational knowledge, cross-functional experience in the organization, and extensive knowledge of the subject domain. It can be challenging for business or project managers to quickly create teams with a relatively large group of people from different departments in different locations in an organization for projects to develop and deliver advanced products and services.

### SUMMARY

In a first aspect of the invention, there is a computer-implemented method including: receiving, by a processor, a project profile including project skills; searching, by the processor, employee profiles for employee skills matching the project skills; selecting, by the processor, at least one group of team candidates having employee profiles with employee skills collectively matching the project skills; determining, by the processor, a synergy score for the at least one group of team candidates; and saving, by the processor, the synergy score and the group of team candidates in persistent storage.

In another aspect of the invention, there is a computer program product including one or more computer readable storage media having program instructions collectively stored on the one or more computer readable storage media. The program instructions are executable to: receive a project profile including project skills; associate a cluster of project profiles with the project profile; identify at least one additional project skill found in common with the project profiles in the cluster and missing from the project profile; add the at least one additional project skill to the project profile; search employee profiles for employee skills matching the project skills; select at least one group of team candidates having employee profiles with employee skills collectively matching the project skills; and save the at least one group of team candidates in persistent storage.

In another aspect of the invention, there is a system including a processor, a computer readable memory, one or more computer readable storage media, and program instructions collectively stored on the one or more computer readable storage media, the program instructions executable to: receive a project profile including project skills; classify employee profiles into classifications based on at least employee skills; identify at least one classification of employee profiles that share at least one project skill of the project profile; search the at least one classification of employee profiles for employee skills matching the project skills; select at least one employee profile from the at least one classification of employee profiles matching the at least one project skill; add the at least one employee profile in at least one group of team candidates; determine a synergy score for the at least one group of team candidates; and save the at least one group of team candidates in persistent storage.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment in accordance with aspects of the invention.

FIG. 3 depicts abstraction model layers in accordance with aspects of the invention.

FIG. 4 depicts an illustration of an exemplary process flow diagram in accordance with aspects of the invention.

FIG. 5 depicts an illustration of an exemplary process flow diagram in accordance with aspects of the invention.

FIG. 6 depicts an illustration of an exemplary data table in accordance with aspects of the invention.

FIG. 7 depicts an illustration of an exemplary visualization in accordance with aspects of the invention.

FIG. 8 shows a block diagram in an exemplary environment in accordance with aspects of the invention.

FIG. 9 shows a flowchart of an exemplary method in accordance with aspects of the invention.

### DETAILED DESCRIPTION

Aspects of the present invention relate generally to the formation of project teams and, more particularly, to systems and method of forming synergistic teams. More specifically, aspects of the invention relate to methods, computer program products, and systems for identifying project teams of employees who have required project skills, work well together creating synergy by combining or complimenting talents, and interconnect between different roles and departments in an organization dependent upon each other for producing project deliverables.

Implementations of the invention profile organizational projects using machine learning clustering and identify characteristics common in effective and successful projects in a cluster. Implementations of the invention also profile employees using machine learning classification and identify synergies of employees working well together as well as interconnections between employees and different roles and departments in an organization dependent upon each other for successful work production.

Moreover, according to aspects of the invention, the methods, systems and computer program products described herein generate project profiles improved by adding missing resources common to similar successful projects, search employee profiles for matching skill sets, synergy working with other employees and dependent interconnections between employees and departments in an organization for successful work production, determine synergy scores for groups of team candidates, and select the team of employees with the highest synergy score for the project.

In embodiments, the methods, systems, and computer program products described herein receive project specifications defining the scope of the project, requirements, deliverables, project timeline, and other parameters. From the project specifications, the methods, systems, and computer program products described herein generate a project profile including project skills, project job functions, and other project attributes and improve the project profile in embodiments by adding missing resources common to similar successful projects of the organization. Employee profiles are searched in embodiments for skill sets matching the project skills, synergy working with other employees and dependent interconnections between employees and departments in the organization for successful work production, and groups of team candidates are selected. Synergy scores are determined in embodiments for the groups of team candidates that include a score of how well the skill sets of the groups of team candidates match the skill sets required by the project profile, a score of how well the group of team candidates work together, and a score of the dependent interconnections between the group of team candidates and departments in the organization for successful work production. The groups of team candidates are ranked by the synergy scores in embodiments and the highest ranking team of employees is selected for the project.

Aspects of the present invention are directed to improvements in computer-related technology and existing technological processes in automatic team formation for projects. In embodiments, the system, methods, and computer program product employ a machine learning clustering module that clusters project profiles by similar successful projects and employs a clustering model trained to identify cluster membership for a given project profile and resources previously unidentified from the given project profile used in common with successful project profiles in the cluster. The system, methods, and computer program product also employ in embodiments a machine learning classification module that classifies employee profiles by similar job skills, publications, and other attributes or features such as job function, department, locality, and so forth, and employs a classification model trained to receive a given employee profile and assign an employee classification of the employee profile. Using the machine learning clustering module, the clustering model, the machine learning classification module, and the classification model, the system, methods, and computer program product accordingly associate a cluster of project profiles with a project profile, identify at least one additional project skill found in common with the project profiles in the cluster and missing from the project profile, add the at least one additional project skill to the project profile, classify employee profiles into classifications based on at least employee skills, identify at least one classification of employee profiles that share at least one project skill of the project profile, search at least one classification of employee profiles for employee skills matching the project skills, select at least one employee profile from the at least one classification of employee profiles matching the at least one project skill, add the at least one employee profile in at least one group of team candidates and determine a synergy score for the at least one group of team candidates. These are specific improvements in the way computers may operate and interoperate to automatically form synergistic teams for projects.

Implementations of the invention describe additional elements that are specific improvements in the way computers may operate and these additional elements provide non-abstract improvements to computer functionality and capabilities. As an example, implementations of the invention profile organizational projects using machine learning clustering and identify characteristics common of effective and successful projects in a cluster. A computer, computer system, and computer program product including one or more computer readable storage media having program instructions collectively stored on the one or more computer readable storage media associates a cluster of project profiles with a project profile, identifies at least one additional project skill found in common with the project profiles in the cluster and missing from the project profile, adds the at least one additional project skill to the project profile. As another example, implementations of the invention also profile employees using machine learning classification and identify synergies of employees working well together as well as interconnections between employees and different roles and departments in an organization dependent upon each other for successful work production. These examples of additional elements provide non-abstract improvements to computer functionality and capabilities.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

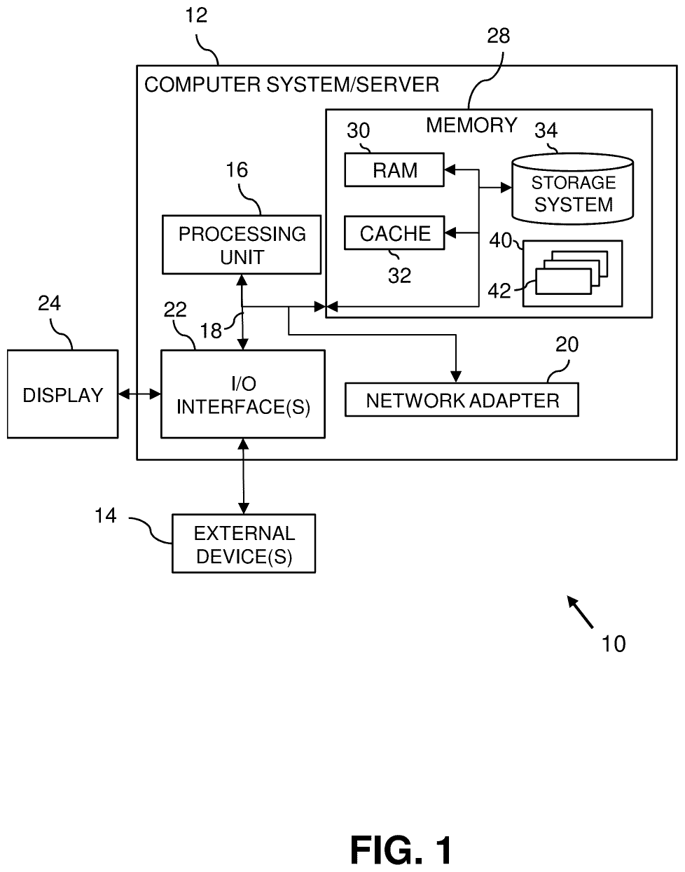

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

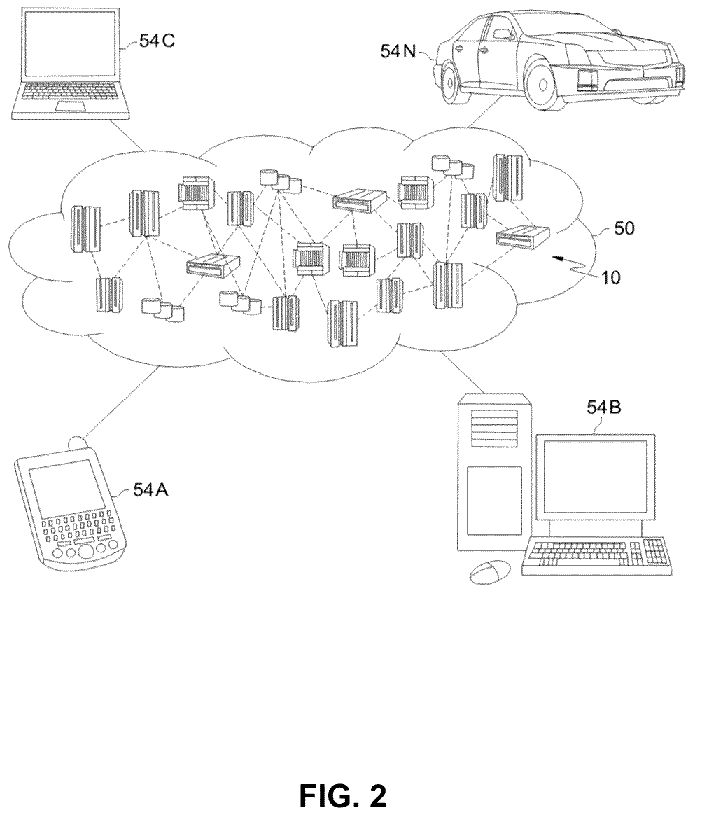

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

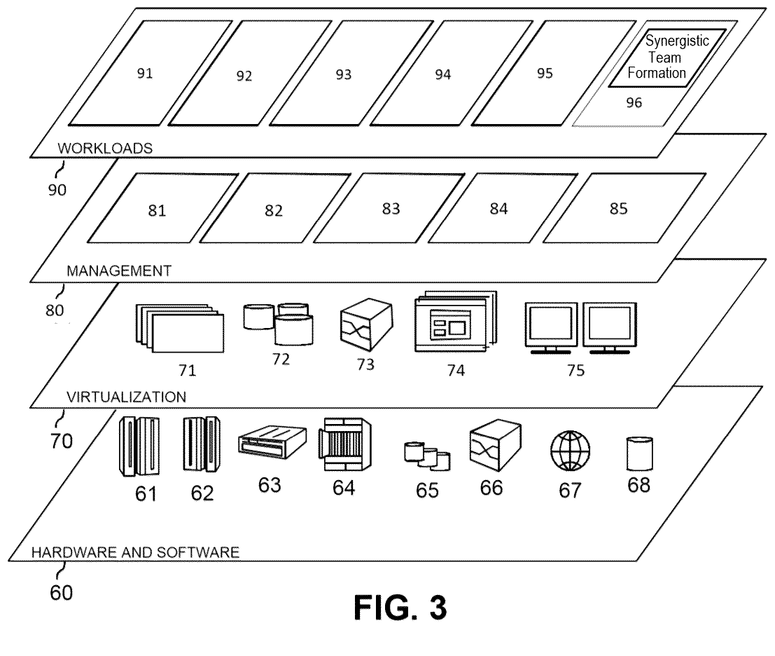

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and synergistic team formation processing 96.

Implementations of the invention may include a computer system/server 12 of FIG. 1 in which one or more of the program modules 42 are configured to perform (or cause the computer system/server 12 to perform) one of more functions of the synergistic team formation processing 96 of FIG. 3. For example, the one or more of the program modules 42 may be configured to receive project specifications, update the resources of the project profile, search employee profiles for matching skill and synergies working with other candidates, determine synergistic scores for team candidates, and output the highest ranking teams as further described herein in more detail.

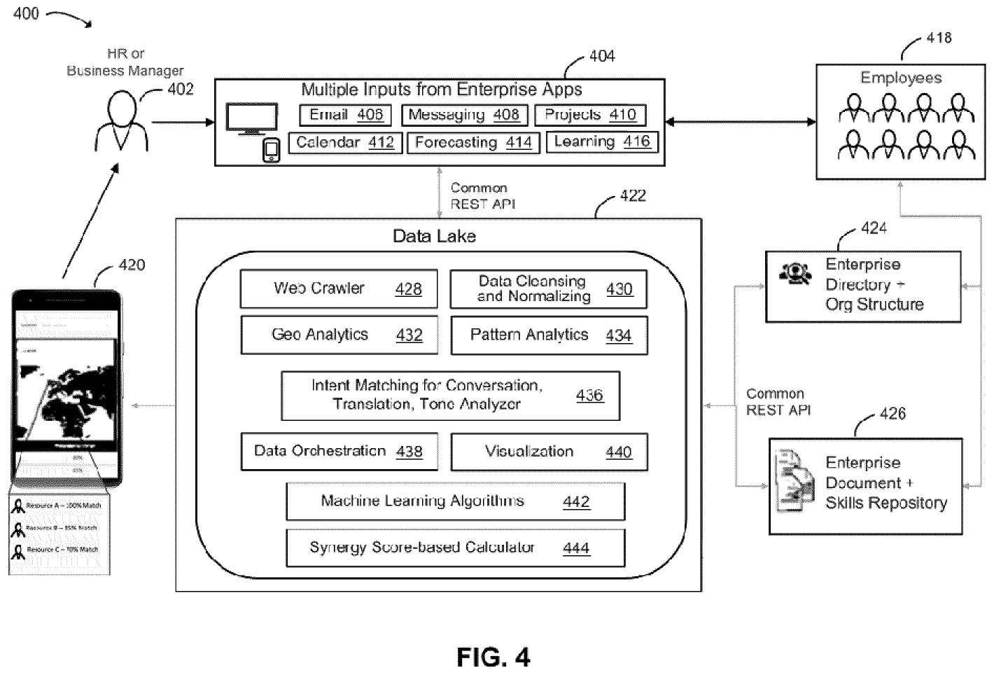

FIG. 4 depicts an illustration of exemplary components in an exemplary process flow diagram in accordance with aspects of the invention. In embodiments, the diagram 400 of FIG. 4 illustrates several sources that provide information of synergy of employees working well together and several components that determine synergy of employees working well together. For example, human relations or business manager 402 is responsible for forming a team for a project and uses the present invention to select a synergistic team. Multiple inputs from enterprise applications 404 used by employees 418 may provide information of synergy of employees working well together such as collaboration tools, e.g., email 406 and messaging 408, as well as other enterprise applications including projects 410, calendar 412, forecasting 414 and learning 416.

For instance, emails exchanged among employees provide a wealth of information about their synergy working together, including the frequency of communications, the tone of the communications, the subject matter domain of the communications, and other indications of the quality of the communications working together. Such communications furthermore can provide information about any dependencies an employee may have upon employees in other departments of the organization for information necessary to carry out the employee's job responsibilities.

These communications and information from enterprise applications 404 are input into data lake 422, for instance using a common REST API, along with information from the enterprise directory and organization structure 424 and enterprise document and skills repository 426. These sources populate the data lake with employee information including profiles, roles in the organization, skills and experiences.

In addition to sources of information illustrated in the diagram of FIG. 4 that provide information of synergy of employees, several components for processing the information and determining synergy are illustrated in data lake 422. For example, the web crawler component 428 validates employee skills. For each skill listed for the employee, the component searches through trusted resources such as internal organization learning portals, publishing sites, and source repositories as well as external sources such as LinkedIn, GitHub and various known academic and industry websites and journals, e.g., the Association for Computing Machinery (ACM). The web crawler component 428 assigns a score ranging, for example, from 1-5 to the crawled search results and persists the results in the data lake. The data cleansing and normalizing component 430 cleanses and normalizes the data in the data pipeline for storage in the data lake by removing duplicates, converting data types and applying other data cleansing and normalizing techniques.

The geographical analytics component 432 obtains geographic employee profile data and organizational employee profile data from the enterprise directory and organization structure and persists this data in the data lake. For instance, such data includes geographic location, reporting chain, current and past roles, years of experience, skills with a skill level ranging, for example, from 1-5. The pattern analytics component 434 discovers patterns of synergy in communications of employees working well together and assigns a score ranging, for example, from 1-5 to patterns recognized by the pattern analytics component 434.

The component for intent matching of conversation, translation and tone analyzer 436 provides the purpose of employee communications and analysis of emotions and communications styles to assess synergies of employees. A synergy score ranging, for example, from 1-5, is assigned for employee communications with aligned purposes of communication and positive emotions and communication styles. The data orchestration component 438 manages data input into the data pipeline, including data cleansing and normalization, stages components that process the data to determine synergy of employees working together, and stores the data and processing results in the data lake. The visualization component 440 provides a visualization of formed synergistic teams that may be sent to a user device for display.

The machine learning algorithms component 442 provides clustering algorithms and a clustering model that clusters project profiles by similar successful projects and identifies common characteristics, including resources such as particular project skills or types of job functions of team members for example, shared by similar successful projects in each cluster of project profiles. For example, k-means clustering, agglomerative hierarchical clustering, or other clustering algorithms may be used in embodiments. The machine learning algorithms component 442 also provides classification algorithms and a classification model that classifies employee profiles, for instance by similar job skills, publications, and other attributes or features, and assigns an employee classification to a given employee profile input to the classification model. In embodiments, naïve bayes, support vector machines, or other classification algorithms may be used.

The synergy score-based calculator 444 determines a synergy score of how well two employees work together and determines a synergy score for groups of employees in embodiments Additionally, the synergy score-based calculator 444 determines a dependency score of an employee dependent upon departments of the organization for the employee to carry out the employee's job responsibilities. The synergistic team formed from information of synergy of employees working well together is represented by a visualization and sent by the visualization component 440 to a user device 420 for display.

Those skilled in the art will appreciate that other components may be used to process sources of information of synergy of employees such as, for instance, an email and persistent messaging crawler component that searches through email for senders/receivers and subjects and persistent communication channels. This component can, for example, determine a frequency score for communication between employees and stores the frequency store in the data lake.

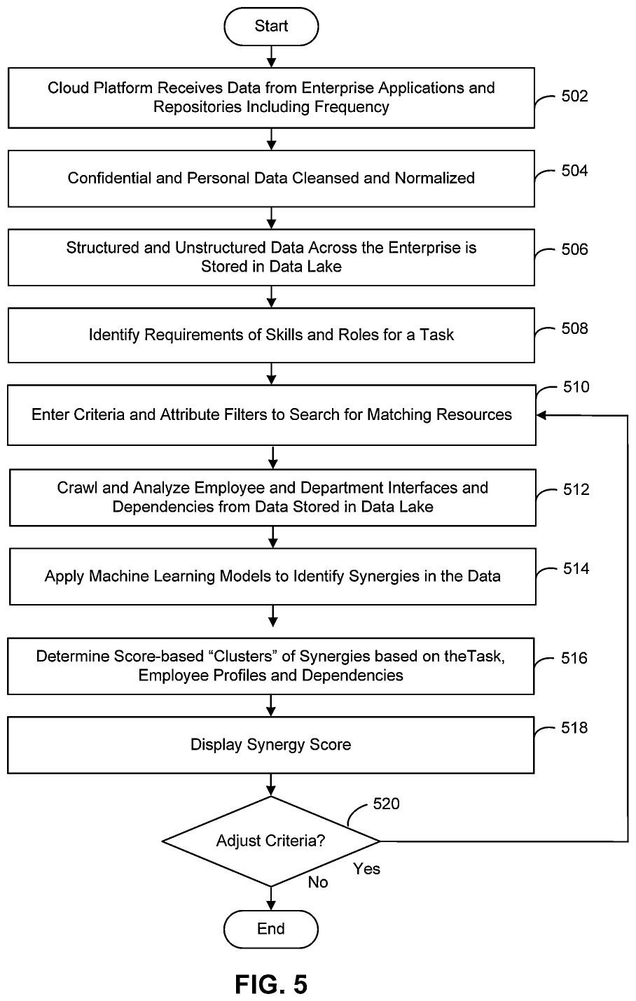

FIG. 5 depicts an illustration of an exemplary process flow diagram in accordance with aspects of the invention. In embodiments, the process flow diagram of FIG. 5 illustrates steps of forming a synergistic team for a project from several sources that provide information of synergy of employees working well together and dependencies of employees upon departments. At step 502, the cloud platform receives data from enterprise applications and repositories including frequency of communications. For example, multiple inputs from enterprise applications 404 described with respect to FIG. 4 may provide information of synergy of employees working well together such as collaboration tools like email 406 and messaging 408, as well as other enterprise applications including projects 410, calendar 412, forecasting 414 and learning 416, each described with respect to FIG. 4.

At step 504, confidential and personal data is cleansed and normalized. For instance, the data cleansing and normalizing component 430 described with respect to FIG. 4 can anonymize, cleanse, and normalize the data in the data pipeline for storage applying data cleansing and normalizing techniques. At step 506, structured and unstructured data across the enterprise is stored in the data lake. The communications and information from enterprise applications 404 are input into data lake 422, for instance using a common REST API, along with information from the enterprise directory and organization structure 424 and enterprise document and skills repository 426 as described with respect to FIG. 4. These sources populate the data lake with structured and unstructured employee data including profiles, roles in the organization, skills and experiences.

At step 508, requirements for skills and roles for a task are identified. For example, a business manager 402, responsible for forming a team for a project, uses the systems and methods described herein to select a synergistic team for a given project as described with respect to FIG. 4. The project specifications may include, e.g., requirements for skills and roles for tasks outlined in the project specifications. The skills outlined in the project specification may include, for instance, proficiency in Java (level 4), NodeJS (level 4), Postgresql database (level 3), and OpenShift (level 5). Experience and experience levels may additionally be outlined in the project specification such as web application UI development experience (level 4), web application business logic development experience (level 4), database logical design (level 3), cloud SaaS experience (level 4), retail industry knowledge (level 5), cloud application security (level 5), container platform knowledge and building CI/CD pipeline experience (level 5).

At step 510, criteria and attribute filters are entered in a user device to define the scope of the search for matching resources. The user device 420 illustrated in FIG. 4 may receive the criteria and attribute filters entered by a user, such as the business manager, to define the search criteria. In embodiments, filters that can be applied include location, region, language and/or other attribute values associated with employee profiles. At step 512, employee and department dependencies stored in the data lake are crawled and analyzed. For example, the email and persistent messaging crawler component as described above with respect to FIG. 4 can search through emails exchanged among employees for information about their synergy working together, including the frequency of communications, the tone of the communications, the subject matter domain of the communications, and any dependencies an employee may have upon employees in other departments of the organization for information necessary to carry out the employee's job responsibilities. Additionally, the geographical analytics component 432 described with respect to FIG. 4 obtains organizational employee profile data from the enterprise directory and organization structure persisted in the data lake.

At step 514, machine learning models are applied to identify synergies in the data. The machine learning algorithms component 442 described with respect to FIG. 4 provides clustering algorithms and a clustering model that clusters project profiles by similar successful projects and identifies common characteristics, including resources such as particular project skills or types of job functions of team members for example, shared by similar successful projects in each cluster of project profiles. The machine learning algorithms component 442 described with respect to FIG. 4 provides classification algorithms and a classification model that classifies employee profiles, for instance by similar job skills, publications, and other attributes or features, and assigns an employee classification to a given employee profile input to the classification model. Employee profiles are searched within employee classifications for matching skill sets of the project profile and synergy working with other employees and departments.

At step 516, score-based clusters of synergies based on the task, employee profiles and dependencies are determined. For example, a score of how well the task skills match the employee skills is determined, a synergy score of how well two employees work together is determined, and a dependency score of employees dependent upon departments of the organization for the employee to carry out the employee's job responsibilities is determined by the synergy score-based calculator 444 described with respect to FIG. 4. At step 518, the synergy score is displayed, for instance, in a visualization of a formed team on a user device such as user device 420 described with respect to FIG. 4.

At step 520, it is determined if the criteria and/or attribute filters are adjusted. For example, the user device 420 illustrated in FIG. 4 may receive adjusted criteria and attribute filters entered by a user, including location, region, language and/or other attribute values associated with employee profiles. If not, then processing is finished. Otherwise, carrying out the steps of the exemplary process flow diagram continues at step 510.

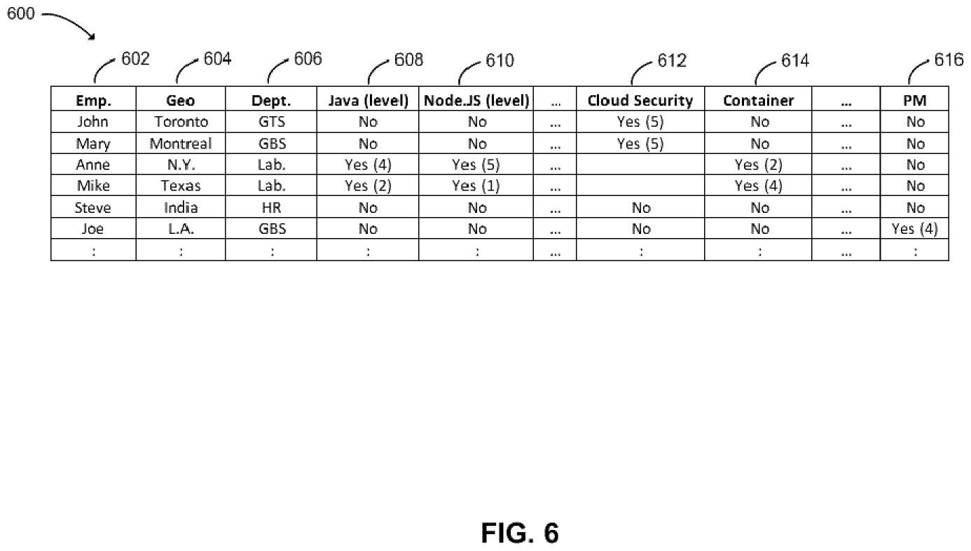

FIG. 6 depicts an illustration of an exemplary data table of exemplary employee skills, in accordance with aspects of the invention. In an embodiment, the illustration 600 depicts an exemplary data table with a column of employee names 602, a column of geographical locations 604, a column of departments of an organization 606, and columns of employee skills data such as a column of Java skills data 608, a column of Node_JS skills data 610, a column of cloud security skills data 612, a column of container skills data 614, and a column of program management skills data 616. A project specification may outline skills including, for instance, proficiency in Java (level 4), NodeJS (level 4), and Postgresql database (level 3), web application UI development experience (level 4), cloud SaaS experience (level 4), retail industry knowledge (level 5), and cloud application security (level 5). Although the project specification may not indicate program management (PM) experience is necessary, the clustering model described with respect to FIG. 4 indicates that a PM should be engaged for this type of project in this case. In the exemplary data table, employee Joe has the requisite PM experience and would receive a high score for how well the PM skill for the project matches Joe's skills. Accordingly, Joe is selected as part of the project team in this example.

In the exemplary data table, employees Mary and John have similar skill sets, but they belong to different departments and are located in different cities. Although Mary and John would receive the same score for how well the task skills match their employee skills, Mary receives a higher synergy score because Joe was selected as a member of the project team and Mary and Joe belong to the same department. Furthermore, Mary and Joe have frequent communications based on analysis of their company e-mail and other collaboration tools. Accordingly, Mary is selected as part of the project team in this example.

In the exemplary data table, Anne and Mike belong to the same department and have similar skill sets in subject domains but are located in different states. For instance, Anne has a higher proficiency level in Java and Node_JS than Mike, while Mike has a higher proficiency level in container skills than Anne. For the skills outlined in the project specification of Java (level 4) and NodeJS (level 4), Anne would receive a higher score than Mike for how well the task skills match her employee skills. Accordingly, Anne is selected as part of the project team in this example.

Continuing the above example, both Joe and Mary have frequent communications based on analysis of their company e-mail and other collaboration tools with Steve who is located in India. Steve receives a high synergy score for how well he works together with Joe and how well he works together with Mary. Although human resource skills are not identified as a required skill or resource in the project specification, Steve is selected as part of the project team in this example because Steve's involvement improves the efficiency of the project.

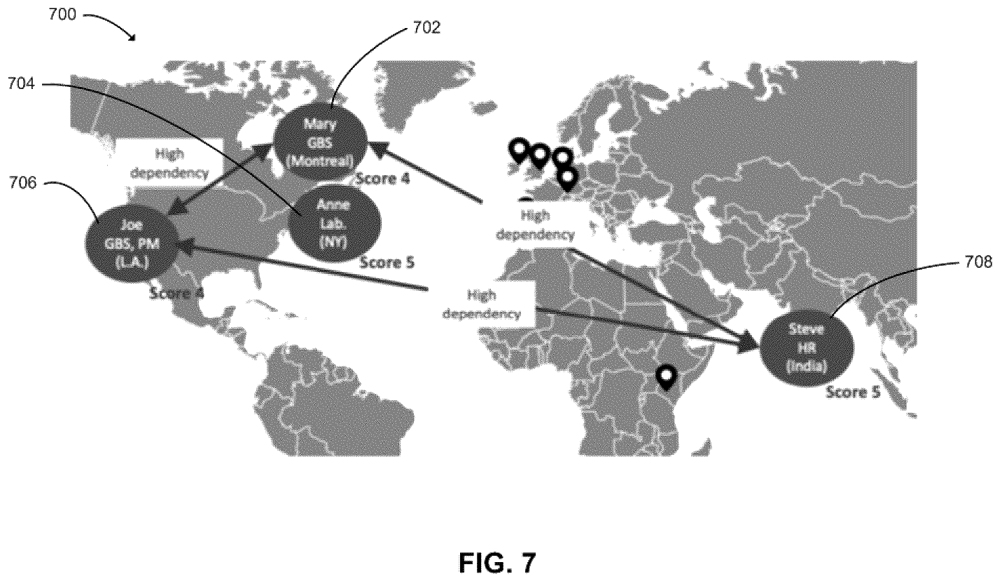

FIG. 7 depicts an illustration of an exemplary visualization of a synergistic team formed for a project, in accordance with aspects because of the present invention. The illustration of visualization 700 depicts geographical locations of employees on a world map that were selected as part of the project team in the example described above with respect to FIG. 6. Employee Mary 702 is shown on the map in Montreal with a score of 4; employee Anne 704 is shown on the map in New York with a score of 5; employee Joe 706 is shown on the map in Los Angeles with a score of 4; and employee Steve is shown on the map in India with a score of 5. The visualization of the synergistic team formed for the project is displayed on a user device such as user device 420 described with respect to FIG. 4.

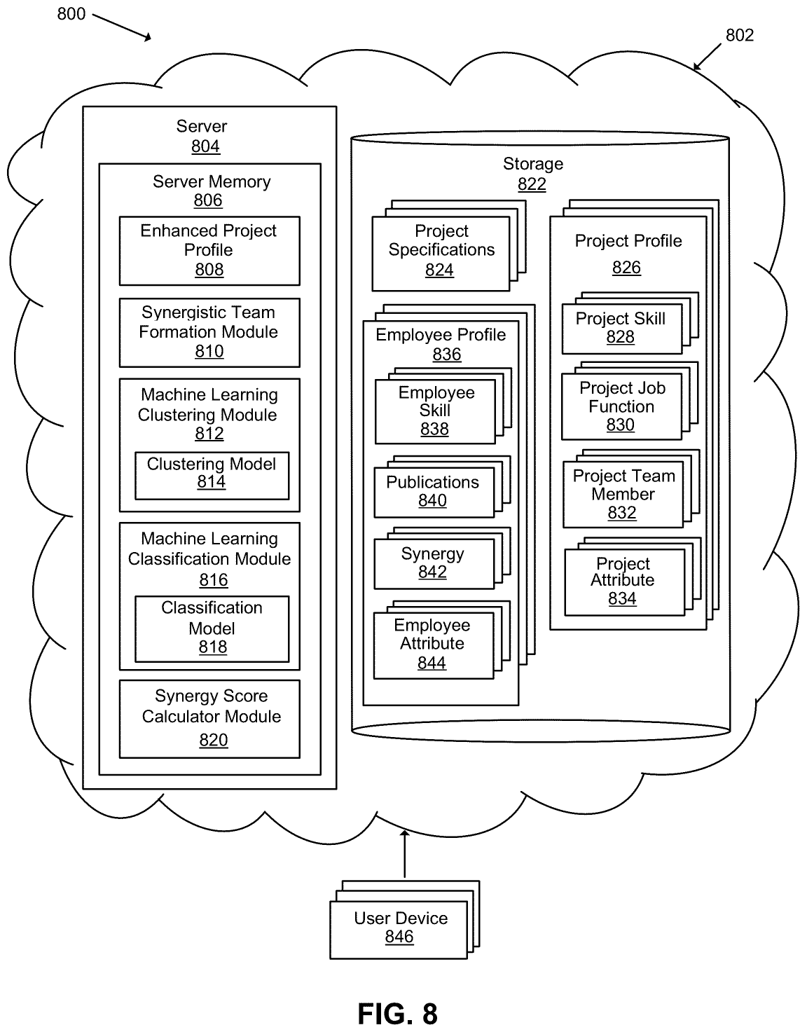

FIG. 8 shows a block diagram of a server in a cloud computing environment in accordance with aspects of the present invention. In embodiments, the cloud computing environment 800 includes a server 804, which may be a computer system such as a computer system 12 described with respect to FIG. 1 and is a cloud computing node such as cloud computing node 10 described with respect to FIG. 2 with which computing devices used by cloud consumers may communicate over a network 802. In general, the server 804 supports services for updating the resources of a project profile, searching employee profiles for matching skills and synergy working with other candidates and outputting the highest ranking teams by synergy scores.

The server 804 has a server memory 806 such as memory 28 described with respect to FIG. 1. The server 804 includes, in memory 806, an enhanced project profile 808 generated from project specifications such as project specifications 824 and updated to add and/or refine project resources identified from similar historical project profiles such as project profiles 826. The server 804 also includes, in memory 806, a synergistic team formation module 810 having functionality to receive project specifications, generate a project profile from the project specifications, update the project resources from similar historical project profiles and generate an enhanced project profile, and search employee profiles for matching skill sets of the enhanced project profile and synergy working with other candidates.

The server 804 also includes, in memory 806, a machine learning clustering module 812 having functionality to cluster project profiles by similar successful projects and identify common characteristics, including resources such as particular project skills or types of job functions of team members for example, shared by similar successful projects in each cluster of project profiles. The machine learning clustering module 812 includes a clustering model 814 trained to identify cluster membership for a given project profile input into the clustering model 814 and resources previously unidentified from the given project profile used in common with successful project profiles in the cluster, including project skills, types of job functions and person-hours spent for job functions. In embodiments, the clustering model 814 may use, for example, k-means clustering, agglomerative hierarchical clustering, or other clustering algorithms. The synergistic team formation module 810 generates an enhanced project profile, such as enhanced project profile 808, that includes such previously unidentified resources recommended by the clustering model 814 missing from the given project profile.

The server 804 also includes, in memory 806, a machine learning classification module 816 having functionality to classify employee profiles by similar job skills, publications, and other attributes or features such as job function, department, locality, and language, to name a few. The machine learning classification module 816 includes a classification model 818 trained to receive a given employee profile input into the classification model 818 and assign an employee classification of the employee profile. In embodiments, naïve bayes, support vector machines, or other classification algorithms may be used. When selecting team members for the project, employee profiles within an employee classification are considered by the synergy team formation module 810 for employee classifications satisfying resources specified by the enhanced project profile 808.

The server 804 also includes, in memory 806, a synergy score calculator module 820 having functionality to determine synergy scores for groups of team candidates that have matching skill sets of the enhanced project profile and synergy working with other candidates, ranking the groups of team candidates by synergy scores, and outputting the highest ranking teams that satisfy the enhanced project profile requirements by synergy scores for a predetermined number of teams. In embodiments, the synergy score may be a value between 0 and 5 that represents how well pairs of members of the team work together from their previous opportunities of working together. Additionally, a score, for instance from 0 to 5, representing the dependencies of relationships of each member upon departments of the organization may be generated from a dependency mapping of an employee upon the departments of the organization. The synergy score and the score representing dependencies may be weighted based upon importance, combined and normalized to a value between 0-1.

In embodiments, the synergistic team formation module 810, the machine learning clustering module 812, the machine learning classification module 816, and the synergy score calculator module 820 may comprise one or more program modules such as program modules 42 described with respect to FIG. 1. The server 804 may include additional or fewer modules than those shown in FIG. 8. In embodiments, separate modules may be integrated into a single module. Additionally, or alternatively, a single module may be implemented as multiple modules. Moreover, the quantity of devices and/or networks in the environment is not limited to what is shown in FIG. 8. In practice, the environment may include additional devices and/or networks; fewer devices and/or networks; different devices and/or networks; or differently arranged devices and/or networks than illustrated in FIG. 8.

In accordance with aspects of the invention, FIG. 8 also shows a block diagram of storage 822 in a cloud computing environment. In embodiments, the cloud computing environment 800 may be a computer system such as a computer system 12 described with respect to FIG. 1 having computer storage such as storage system 34 also described with respect to FIG. 1 and may be a cloud computing node such as cloud computing node 10 described with respect to FIG. 2 with which computing devices used by cloud consumers may communicate over a network 802. In general, storage 822 may store project specifications 824 in files defining the scope of the project, requirements, deliverables, project timeline, and other parameters including payment terms. For example, the project specifications 824 can include a statement of work, project change requests, a project charter, or other types of documents or diagrams defining project requirements.

The storage 822 may also store project profiles 826 in files that include project skills 828, project job functions 830, project team members 832, and project attributes 834. For example. the project skills 828 may be in an embodiment programming skills in a programming language such as Java, NodeJS, C++ or other programming languages, project management skills in project development methodologies such as agile methodology, waterfall methodology, lean methodology or other development methodology, marketing skills in advertising, direct marketing, search engine optimization (SEO) or other marketing skills, and so forth. Each project skill in embodiments can include an associated level of proficiency, for instance ranging from 1 to 5 in an embodiment. Project job functions 830 include various business, development and administration roles in an organization such as programmer, architect, marketing manager, accountant, sales representative, customer representative, human resources manager, and other organizational roles. Project team members 832 include, e.g., employee name and employee attributes of members of the project. Various other attributes or features may be included in project attributes 834 such as locality, primary language, timeline, among other attributes or features. These specified project features are used by the synergistic team formation module 810 in searching employee profiles for features matching the project profile features in team formation.

Storage 822 may additionally store employee profiles 836 in files that include employee skills 838, publications 840, synergies 842, and employee attributes 844. For example, the employee skills 838 be programming skills in a programming language such as Java, NodeJS, C++ or other programming languages, project management skills in project development methodologies such as agile methodology, waterfall methodology, lean methodology or other development methodology, marketing skills in advertising, direct marketing, search engine optimization (SEO) or other marketing skills, etc. Each employee skill in embodiments can include an associated level of proficiency, for instance ranging from 1 to 5, for example. Publications 840 include in an embodiment publications within an organization and external to the organizations, for instance, in social networks, professional associations, blogs or other publication media.

Synergies 842 include in an embodiment an indication, for instance a rating from 0 to 5, of how well the employee works together with another employee in their previous opportunities of working together. Additionally, synergies 842 include in an embodiment an indication, for example a rating from 0 to 5, of the number of dependencies of the employee upon departments of the organization. Employee attributes 844 include various other attributes or features such as locality, primary language, and department, among other attributes or features. These employee features are searched by the synergistic team formation module 810 for matching the project profile features in team formation.

In accordance with aspects of the invention, FIG. 8 also shows user device 846 that communicates with server 804 and may be a computer system such as a computer system 12 described with respect to FIG. 1. The user device 846 has functionality to receive a visualization of the synergistic team formed by the synergistic team formation module 810 such as visualization 700 described with respect to FIG. 7.

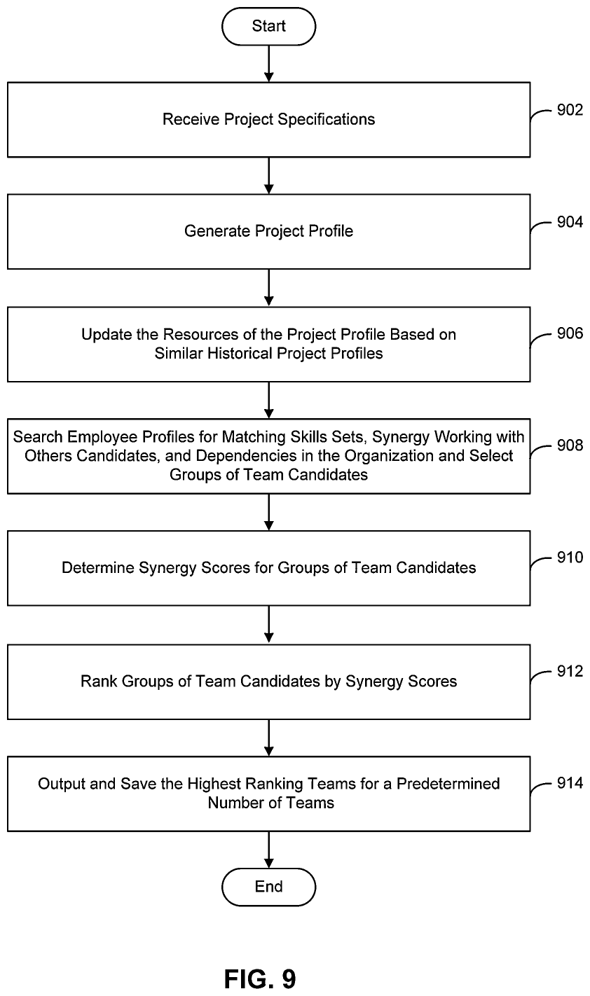

FIG. 9 shows a flowchart and/or block diagram that illustrates the architecture, functionality, and operation of possible implementations of systems, methods, and computer program products according to various embodiments of the present invention. As noted above, each block may represent a module, segment, or portion of instructions, which comprises one or more executable instructions for implementing the specified logical function(s). The functions noted in the blocks may occur out of the order, two blocks shown in succession may, in fact, be accomplished as one step, executed concurrently, substantially concurrently, in a partially or wholly temporally overlapping manner, or the blocks may sometimes be executed in the reverse order, depending upon the functionality involved. And some blocks shown may be executed and other blocks not executed, depending upon the functionality involved.

FIG. 9 shows a flowchart of an exemplary method in accordance with aspects of the present invention. Steps of the method may be carried out in the environment of FIG. 8 and are described with reference to elements depicted in FIG. 8. In particular, the flowchart of FIG. 9 shows an exemplary method for synergistic team formation of employees of an organization for project specifications, in accordance with aspects of the present invention.

At step 902, the system receives project specifications in an embodiment. The project specifications may define the scope of the project, requirements, deliverables, project timeline, and other parameters including payment terms. For example, the project specifications can be a statement of work, project change requests, a project charter, or other types of documents or diagrams defining project requirements. In an embodiment, the synergistic team formation module 810 in server memory 806 described with respect to FIG. 8 may receive project specifications 824 in storage 822 described with respect to FIG. 8.

At step 904, the system generates a project profile. In embodiments, the synergistic team formation module 810 in server memory 806 described with respect to FIG. 8 may generate project profile 826 in storage 822 described with respect to FIG. 8. The synergistic team formation module 810 parses the project specifications 824 in storage 822 and employs natural language processing to extract project profile features from the project specifications 824 and populates a project profile template with the extracted features to build the project profile 826. The project profile includes project skills 828, project job functions 830, project team members 832, and project attributes 834, each described with respect to FIG. 8. For example, project skills 828 may be programming skills in a programming language, project management skills in project development methodologies, marketing skills, and so forth. Each project skill in embodiments can include an associated level of proficiency, for instance ranging from 1 to 5 in an embodiment. Project job functions 830 described with respect to FIG. 8 include in embodiments various business, development, and administration roles in an organization. Project team members 832 described with respect to FIG. 8 include employee name and employee attributes of members of the project. Various other attributes or features may be included in project attributes 834 described with respect to FIG. 8, such as locality, primary language, timeline, among other attributes or features.

At step 906, the system updates the resources of the project profile based on similar historical project profiles. In embodiments, the synergistic team formation module 810 in server memory 806 described with respect to FIG. 8 may generate enhanced project profile 808 in server memory 806 described with respect to FIG. 8 from the project profile by adding missing project resources identified from similar historical project profiles such as project profiles 826. For example, the synergistic team formation module 810 generates enhanced project profile 808 from a given project profile by adding previously unidentified resources recommended by the clustering model 814 missing from the given project profile. The clustering model 814 is trained to identify cluster membership for the given project profile input into the clustering model 814 and to identify resources missing from the given project profile and found in common with successful project profiles in the cluster, including project skills, types of job functions, person-hours spent for job functions among other resources.

At step 908, the system searches employee profiles for matching skill sets, employee synergy working with other candidates, and employee dependencies in the organization upon departments and selects groups of team candidates satisfying resources specified by the enhanced project profile. In embodiments, the synergistic team formation module 810 in server memory 806 described with respect to FIG. 8 searches employee profiles 836 for matching employee skills 838 and employee synergy 842 working with other candidates and employee dependencies in the organization upon departments in storage 822 described with respect to FIG. 8 and selects groups of team candidates satisfying resources specified by the enhanced project profile. For example, the synergy team formation module 810 searches employee profiles 836 within an employee classification for employee classifications satisfying resources specified by the enhanced project profile 808. As described with respect to FIG. 8, the classification model 818 is trained to receive a given employee profile input into the classification model 818 and assign an employee classification of the employee profile. The classification model 818 classifies employee profiles 836 by similar job skills 838, publications 840, and other employee attributes 844 such as job function, department, locality, and language for instance. In embodiments, a score representing how well each group of team candidates satisfies resources specified by the enhanced project profile is determined and groups of team candidates with a score exceeding a predetermined threshold are selected as groups of team candidates.

At step 910, the system determines synergy scores for groups of team candidates that satisfy resources specified by the enhanced project profile. In embodiments, synergy score calculator module 820 determines synergy scores for groups of team candidates that have matching skill sets of the enhanced project profile 808 and synergy working with other candidates. A synergy score of how well two employees work together may be assigned for instance from 0 to 5 that is stored in synergies 842 in storage 822. The synergy score for groups of team candidates may be a value between 0 and 5 that represents how well pairs of members of the group of team candidates work together from their previous opportunities of working together. For example, a synergy score can be assigned based on a predetermined threshold of the number of communications occurring during a defined time period between members of the group of team candidates that use collaboration tools such as email and messaging applications. In embodiments, predetermined thresholds can be defined for communications that occur less than quarterly and assigned a value of 1, for quarterly communications and assigned a value of 2, for monthly communications and assigned a value of 3, for biweekly communications and assigned a value of 4, and for weekly communications and assigned a value of 5. Additionally, a score, for instance from 0 to 5, representing the dependencies of relationships of each member upon departments of the organization may be generated from a dependency mapping of an employee upon the departments of the organization. The synergy score and the score representing dependencies may be weighted based upon importance, combined and normalized to a value between 0-1.

The dependency of an employee upon departments of the organization represents information provided by a department of the organization on an occasional or regular basis to the employee that the employee is dependent upon for the employee to carry out the employee's job responsibilities or information needed to be provided by the employee on an occasional or regular basis to a department of the organization for another employee belonging to that department to carry out that employee's job responsibilities.

In embodiments, synergy score calculator module 820 determines efficiency scores for groups of team candidates that represent how efficiently the groups of team candidates can complete the project, including project cost and project duration. For example, one group of team candidates may include one senior member with a $300 per hour billing rate, two intermediate level members with a $200 per hour billing rate, and five associate members with a $80 per hour billing rate to complete a project within 7 hours at a cost of $7,700. Another group of team candidates may include three senior members and two associate members to finish the same project within 10 hours at a cost of $11,600. In this example, synergy score calculator module 820 determines a higher efficiency score for the group of team candidates that can complete the project within 7 hours at a cost of $7,700 for less cost and in less time than the other group of team candidates eventhough there are more team members. In determining efficiency scores, synergy score calculator module 820 considers additional features like geographical distance, time zones, departments in the organization and so forth.

In embodiments, the determination of the synergy scores for groups of team candidates also includes the score representing how well each group of team candidates satisfies resources specified by the enhanced project profile. In embodiments, the synergy score, the score representing dependencies, the score representing how well each group of team candidates satisfies resources specified by the enhanced project profile, and the efficiency score representing how efficiently each group of team candidates can complete the project may be weighted based upon importance, combined and normalized to a value between 0-1.

At step 912, the system ranks groups of team candidates by synergy scores. In embodiments, synergy score calculator module 820 ranks the groups of team candidates by synergy scores. In embodiments, the synergy score calculator module 820 may rank the group of team candidates by synergy scores representing how well pairs of members of the group of team candidates work together from their previous opportunities of working together. In embodiments, the synergy score calculator module 820 may also rank the group of team candidates by combining the synergy scores representing how well pairs of members of the group of team candidates work together from their previous opportunities of working together and the scores representing the dependencies of relationships of each member upon departments of the organization. In embodiments, the synergy score calculator module 820 may further rank the group of team candidates by combining the synergy scores representing how well pairs of members of the group of team candidates work together from their previous opportunities of working together, the scores representing the dependencies of relationships of each member of the group of team candidates upon departments of the organization, and the scores representing how well each group of team candidates satisfies resources specified by the enhanced project profile. In embodiments, the synergy score calculator module 820 may yet further rank the group of team candidates by combining the synergy scores representing how well pairs of members of the group of team candidates work together from their previous opportunities of working together, the scores representing the dependencies of relationships of each member of the group of team candidates upon departments of the organization, the scores representing how well each group of team candidates satisfies resources specified by the enhanced project profile, and the scores representing how efficiently each group of team candidates can complete the project.

At step 914, the system outputs and saves in persistent storage the highest ranking teams for a predetermined number of teams. In embodiments, synergy score calculator module 820 outputs and saves the highest ranking teams that satisfy the enhanced project profile requirements by synergy scores for a predetermined number of teams. In embodiments, a visualization of a synergistic team formed for a project, such as shown and described with respect to FIG. 7, may be sent by the system to user device 846 for display.

In this way, aspects of the present invention identify project teams of employees who have required project skills, work well together creating synergy by combining or complimenting talents, and interconnect between different roles and departments in an organization dependent upon each other for producing project deliverables.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor, a project profile including project skills;
searching, by the processor, employee profiles for employee skills matching the project skills;
selecting, by the processor, at least one group of team candidates having employee profiles with employee skills collectively matching the project skills;
determining, by the processor, a synergy score based on a predetermined threshold of a number of communications occurring during a defined time period between members of the at least one group of team candidates using collaboration tools including email; and
saving, by the processor, the synergy score and the group of team candidates in persistent storage.

2. The method of claim 1, further comprising:
receiving, by the processor, project specifications; and
generating, by the processor, the project profile from the project specifications.

3. The method of claim 1, further comprising updating, by the processor, resources of the project profile based on similar historical project profiles.

4. The method of claim 1, further comprising:
associating, by the processor, a cluster of project profiles with the project profile using a machine learning clustering model trained to identify cluster membership for the project profile input into the clustering model;
identifying, by the processor, at least one additional project skill found in common with the project profiles in the cluster and missing from the project profile using the machine learning clustering model trained to identify a project skill missing from the project skills of the project profile and found in common with project profiles in the cluster; and
adding, by the processor, the at least one additional project skill to the project profile.

5. The method of claim 1, further comprising:
classifying, by the processor, the employee profiles into classifications based on at least employee skills;
identifying, by the processor, at least one classification of employee profiles that share at least one project skill of the project profile; and
selecting, by the processor, at least one employee profile from the at least one classification of employee profiles to be included in the at least one group of team candidates.

6. The method of claim 1, further comprising searching, by the processor, employee profiles for employee synergies working with other candidates that have at least one employee skill matching at least one project skill.

7. The method of claim 1, further comprising:
ranking, by the processor, the at least one group of team candidates; and
outputting, by the processor, the highest ranking groups of team candidates of the at least one group of team candidates for a predetermined number of teams.

8. The method of claim 1, further comprising determining, by the processor, a score representing dependencies of relationships of each member of the at least one group of team candidates upon departments in an organization.

9. The method of claim 1, further comprising:
determining, by the processor, a score representing how well the employee skills and other features of the employee profiles of the at least one group of team candidates matches the project skills of the project profile; and
determining, by the processor, a score representing how efficiently the at least one group of team candidates can complete tasks of the project profile.

10. The method of claim 1, further comprising sending, by the processor, the synergy score to a user device for display.

11. A computer program product comprising one or more computer readable storage media having program instructions collectively stored on the one or more computer readable storage media, the program instructions executable to:
receive a project profile including project skills;
associate a cluster of project profiles with the project profile using a machine learning clustering model trained to identify cluster membership for the project profile input into the clustering model;
identify at least one additional project skill found in common with the project profiles in the cluster and missing from the project profile using the machine learning clustering model trained to identify a project skill missing from the project skills of the project profile and found in common with project profiles in the cluster;
add the at least one additional project skill to the project profile;
search employee profiles for employee skills matching the project skills;
select at least one group of team candidates having employee profiles with employee skills collectively matching the project skills; and
save the at least one group of team candidates in persistent storage.

12. The computer program product of claim 11, wherein the program instructions are further executable to:
receive project specifications; and
generate the project profile from the project specifications.

13. The computer program product of claim 11, wherein the program instructions are further executable to:
classify the employee profiles into classifications based on at least employee skills;
identify at least one classification of employee profiles that share at least one project skill of the project profile; and
select at least one employee profile from the at least one classification of employee profiles to be included in the at least one group of team candidates.

14. The computer program product of claim 11, wherein the program instructions are further executable to determine a synergy score for the at least one group of team candidates.

15. The computer program product of claim 11, wherein the program instructions are further executable to determine a score representing dependencies of relationships of each member of the at least one group of team candidates upon departments in an organization.

16. The computer program product of claim 11, wherein the program instructions are further executable to:
determine a score representing how well the employee skills and other features of the employee profiles of the at least one group of team candidates collectively matches the project skills of the project profile; and
determine a score representing how efficiently the at least one group of team candidates can complete tasks of the project profile.

17. A system comprising:
a processor, a computer readable memory, one or more computer readable storage media, and program instructions collectively stored on the one or more computer readable storage media, the program instructions executable to:
receive a project profile including project skills;
classify employee profiles using a machine learning classification model trained to classify the employee profiles into classifications based on at least employee skills;
identify at least one classification of employee profiles that share at least one project skill of the project profile;
search the at least one classification of employee profiles for employee skills matching the project skills;
select at least one employee profile from the at least one classification of employee profiles matching the at least one project skill;
add the at least one employee profile in at least one group of team candidates;
determine a synergy score for the at least one group of team candidates; and
save the at least one group of team candidates in persistent storage.

18. The system of claim 17, wherein the program instructions are further executable to:
associate a cluster of project profiles with the project profile using a machine learning clustering model trained to identify cluster membership for the project profile input into the clustering model;
identify at least one additional project skill found in common with the project profiles in the cluster and missing from the project profile using the machine learning clustering model trained to identify a project skill missing from the project skills of the project profile and found in common with the project profiles in the cluster;
add the at least one additional project skill to the project profile.

19. The system of claim 17, wherein the program instructions are further executable to search the employee profiles for employee synergies working with other candidates that have at least one employee skill matching the at least one project skill.

20. The system of claim 17, wherein the program instructions are further executable to determine a score representing dependencies of relationships of each member of the at least one group of team candidates upon departments in an organization.
